(19) United States
(12) Patent Application Publication
(10) Pub. No.: US 2007/0050263 A1
(43) Pub. Date: Mar. 1, 2007

(54) Real estate sales/purchase system

(76) Inventor: Kiyoto Horimoto, Tokyo (JP)

Correspondence Address: MICHAUD-DUFFY GROUP LLP, 306 INDUSTRIAL PARK ROAD, SUITE 206, MIDDLETOWN, CT, 06457, US

(21) Appl. No.: 10/569,291

(22) PCT Filed: Aug. 23, 2004
(86) PCT No.: PCT/JP04/12056

§ 371 Date: Feb. 22, 2006

(30) Foreign Application Priority Data
Aug. 26, 2003 (JP) 2003-301669

(51) Int. Cl. G06Q 30/00

(52) U.S. Cl. 705/26

(57) ABSTRACT

An estate broker 12 offers a property. A customer extraction section 105 extracts customers who desire the offered property. A price range check section 108 checks a price range with a predetermined or more number of customers, and judges the distribution of desired prices. When desired prices are concentrated on a particular price, the number of parcels is determined from the number of extracted customers and minimum parcel area. A parcel pattern selecting section 107 selects a parcel pattern based on the pattern selection reference information. A parcel/price determining section 109 determines a parcel pattern and price based on the parcel pattern information, customer information and pattern selection reference information. When desired prices are not concentrated on a particular price, the number of parcels is determined from the number of extracted customers.

### CROSS REFERENCE TO RELATED APPLICATIONS

This application is based on the Japanese Patent Application No. 2003-301669 filed on Aug. 26, 2003, entire content of which is expressly incorporated by reference herein.

### TECHNICAL FIELD

The present invention relates to a real estate trading system to encourage an estate purchase desirer to contract in a short period to purchase a real-estate property for sale.

### BACKGROUND ART

When an estate purchase desirer purchases a real-estate property for sale, the trade has conventionally been carried out according to procedures as shown in FIG. 1. FIG. 1 is a diagram to explain conventional procedures of real estate trade.

An estate sales desirer 1 requests an estate purchase broker 2a for brokerage of the sale of a property that the desirer 1 owns. The estate purchase broker 2a provides information of the property to a group to which the broker 2a belongs as a distribution property.

The estate purchase broker 2a negotiates with a subdivision business owner 3 who desires to purchase the property. After the establishment of a contract, the subdivision business owner 3 carries out designing and planning, and sells houses on the subdivision through brokerage of an estate sales broker 2b, etc.

The estate sales broker 2b recruits purchase desirers 4 through registration with an affiliated property database 5, etc. The estate purchase desirer 4 searches properties registered with the property database 5 with which the estate sales broker 2b is affiliated for a desired property, through the estate sales broker 2b. When there is a property matching purchase conditions of the estate purchase desirer 4, the estate sales broker 2b negotiates the sale price and so on, and the subdivision business owner 3 contracts the sale with the estate purchase desirer 4.

The property database 5 is accessed through the Internet.

In the conventional distribution of subdivision property, it is difficult for an estate purchase desirer to efficiently find a property matching the desired conditions, and the estate purchase desirer has to obtain information of property from many estate sales brokers that install property databases before finding the property matching the desired conditions.

Further, for an estate purchase broker, even if a property desired to sell is registered with a property database, when the property database is installed in distribution mechanisms of a limited extent, a frequency of access from an estate purchase desirer is low, and it is difficult to sell the property early. Thus, for the estate purchase broker, there are issues such that the close rate per estate purchase desirer is low, and that significant efforts and time is required to establish the contract.

### DISCLOSURE OF INVENTION

It is an object of the invention to provide a real estate trading system enabling matching between a real-estate property for sale and an estate purchase desirer to be performed promptly and efficiently.

The real estate trading system of the invention has a customer information storage that stores customer information including a desired location and desired price, a customer extractor that extracts customers who desire the desired location that is a location of an offered property, a pattern selection reference information acquirer that acquires pattern selection reference information based on distribution of desired prices of extracted customers, a parcel pattern selector that selects a parcel pattern of the offered property based on the pattern selection reference information and the customer information, and a section that provides information of the parcel and price to the extracted customers based on the parcel pattern, the pattern selection reference information and the customer information.

According to this constitution, since offered properties are compared with desired conditions to gain matching, it is possible to find a property matching the desired conditions quickly, and implement the estate trade contract early.

In the real estate trading system of the invention, the pattern selection reference information preferably includes information on whether or not desired prices of the extracted customers are concentrated on a particular price.

In the real estate trading system of the invention, when the desired prices of the extracted customers are concentrated on the particular price, the parcel pattern selector preferably selects a parcel pattern with equally divided parcels.

In the real estate trading system of the invention, when the desired prices of the extracted customers are not concentrated on the particular price, the pattern selection reference information acquirer performs grading corresponding to the desired prices of the extracted customers, and the parcel pattern selector preferably selects a parcel pattern in consideration of the grading.

In the real estate trading system of the invention, the offered property is preferably trimmed in the shape of a rectangle.

### BRIEF DESCRIPTION OF DRAWINGS

FIG. 1 is a diagram to explain conventional procedures of real estate trade;

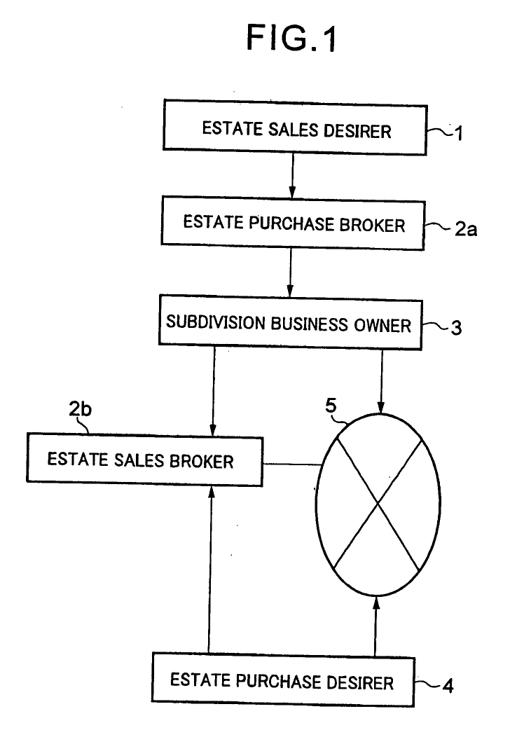

FIG. 2 is a diagram showing a schematic configuration of a real estate trading system according to a first embodiment of the present invention;

FIG. 3 is a view showing an example of an input screen used in the real estate trading system according to the first embodiment of the invention;

FIG. 4 is a view showing examples of a parcel pattern used in the real estate trading system according to the first embodiment of the invention;

FIGS. 5A to 5C are views to explain parcels in the real estate trading system according to the first embodiment of the invention;

FIG. 6 is a flowchart to explain procedures in the real estate trading system according to the first embodiment of the invention;

FIG. 7 is a graph showing an example of distribution of the number of desirers with respect to a property to sell used in the real estate trading system according to the first embodiment of the invention;

FIG. 8 is a graph showing another example of distribution of the number of desirers with respect to a property to sell used in the real estate trading system according to the first embodiment of the invention; and

FIGS. 9A to 9C are views showing examples of a parcel pattern in the real estate trading system according to a second embodiment of the invention.

### DETAILED DESCRIPTION OF THE PREFERRED EMBODIMENTS

Real estate trading systems according to embodiments of the invention will specifically be described below with reference to accompanying drawings.

### First Embodiment

This embodiment describes the case where a real-estate property for trade is a land or a stand-alone house. Accordingly, a plane pattern is used as a parcel pattern.

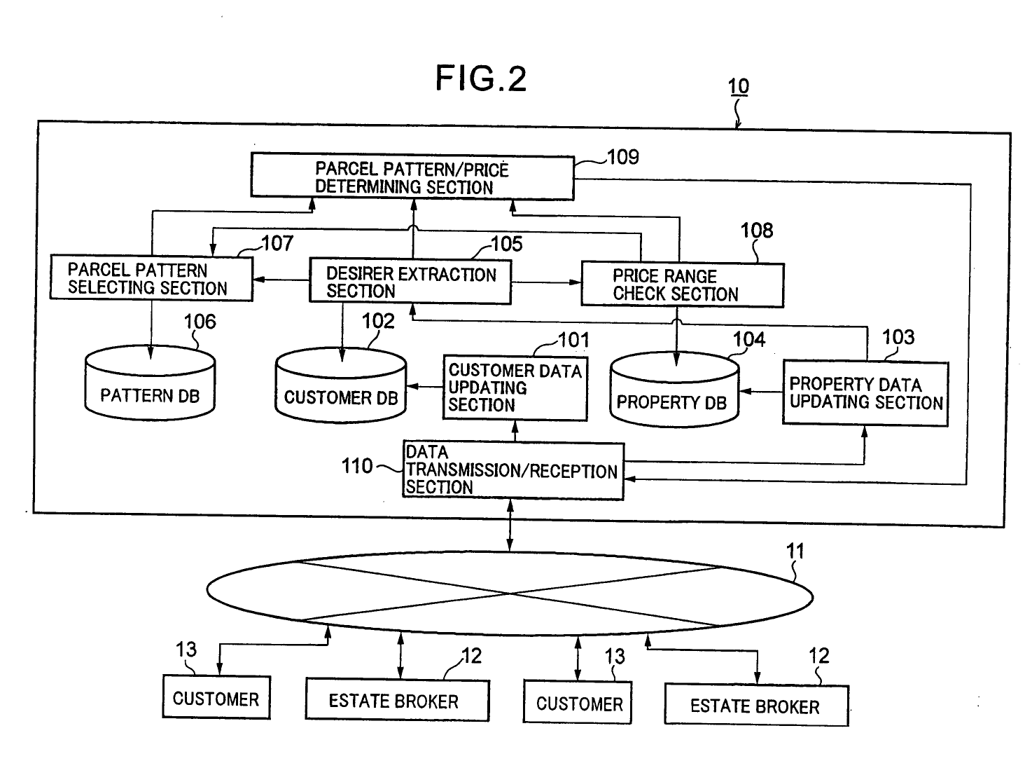

FIG. 2 is a diagram showing a schematic configuration of a real estate trading system according to the first embodiment of the invention. The real estate trading system as shown in FIG. 2 includes a real estate trade management center 10. The real estate trade management center 10 is connected to customers (estate purchase desirers) 13 and estate brokers 12 having real estate properties for sale via a network 11 such as the Internet. Accordingly, the customer 13 registers customer information with the real estate trade management center 10 via the network 11, and the real estate trade management center 10 provides information (parcel pattern, price and the like) of a property that the customer 13 desires via the network 11. Further, the estate broker 12 provides information of a property for sale to the real estate trade management center 10 via the network 11.

The real estate trade management center 10 is principally comprised of a customer data updating section 101, customer database (customer DB) 102, property data updating section 103, property database (property DB) 104, desirer extraction section 105, parcel pattern database (pattern DB) 106, parcel pattern selecting section 107, price range check section 108, parcel pattern/price determining section 109 and data transmission/reception section 110.

The data transmission/reception section 110 receives property data such as properties for sale from the estate brokers 12 and customer data from the customers 13 via the network 11, while transmitting information such as a parcel pattern and price determined in the real estate trade management center 10 to the customers 13 via the network 11.

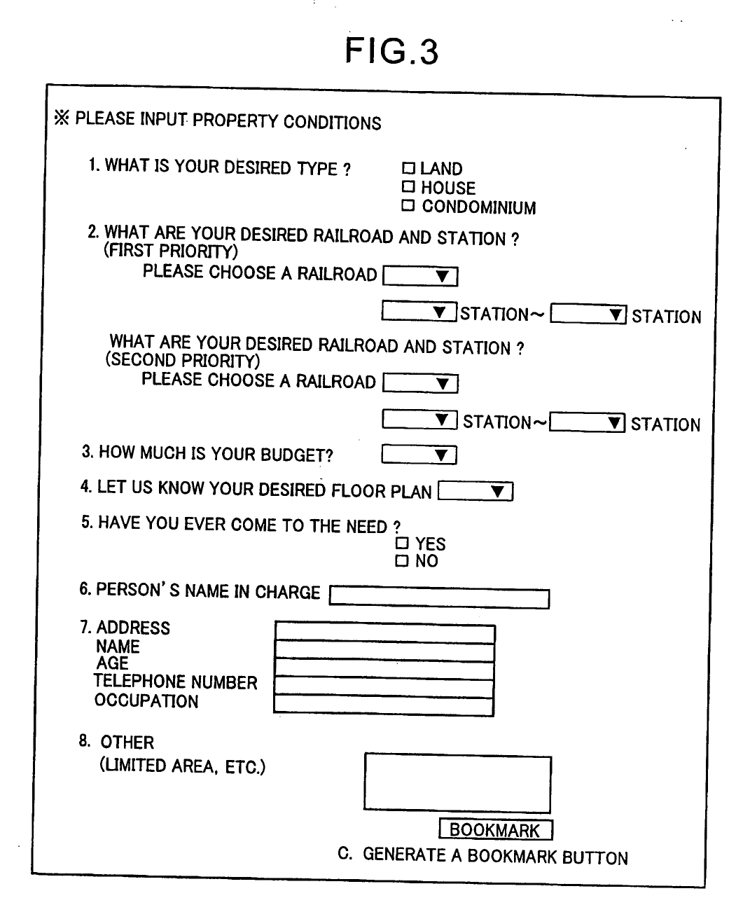

The customer data updating section 101 receives data input by the customers 13 on the site to write in the customer DB 102. By this means, the customer data updating section 101 manages the customer data of customers 13 registered with the system. More specifically, for example, on an input screen on the site as shown in FIG. 3, the customer inputs a type of property, desired railroad and station, budget (desired price), floor plan of a house, person in charge, personal information (such as an address, name, age, occupation and telephone number) and so on. Based on the input data, the customer DB 102 stores the data input on the site for each customer.

The property data updating section 103 receives the property data such as properties for sale input by the estate brokers 12 on the site to write in the property DB 104. By this means, the property data updating section 103 manages the property data that the estate brokers provide to the system.

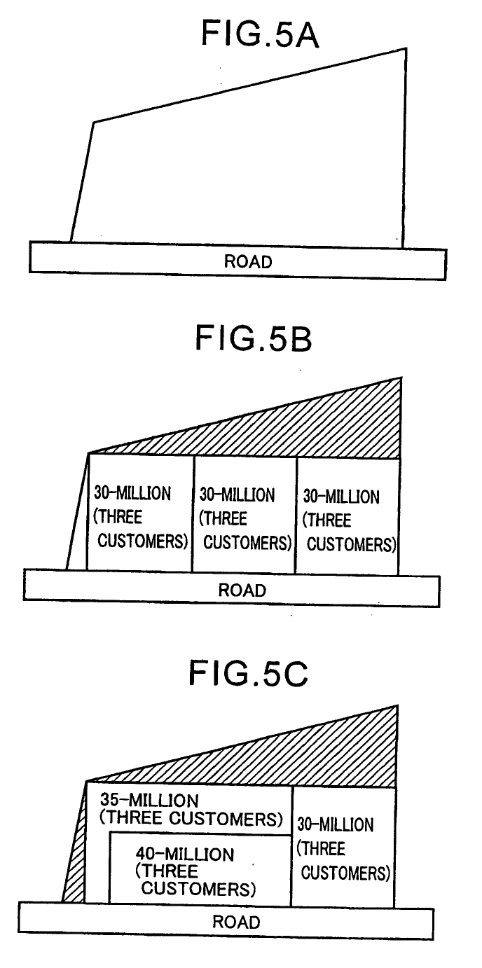

In addition, used for the property data is a beforehand trimmed (shaped) property (in the shape of a rectangle) enabling easy parceling (see FIG. 5). Accordingly, the property data includes data such as a frontage and depth of a parcel in the property trimmed in the shape of a rectangle. The trimming processing may be carried out manually by input means not shown, or performed automatically by the property data updating section 103. Otherwise, the estate broker 12 may transmit the property data of a trimmed property.

The desirer extraction section 105 extracts customers who desire the property from the customer DB 102 based on the property data from the estate broker 12. In other words, the desirer extraction section 105 extracts from the customer DB 102 customers who describe the railroad and station nearby the property provided by the estate broker 12 as the desired railroad and station. In this case, it may be possible to extract all the customers who describe the railroad and station nearby the provided property as the desired railroad and station, or it may be possible that the maximum number of extracted customers is beforehand set and that a predetermined number of customers are only extracted. In the case of limiting customers to the predetermined number, it may be possible to extract customers in ascending order of the time the customer registered the data with the system, or extract based on other information such as the price.

The price range check section 108 extracts a price range desired by a predetermined or more number of customers among the customers extracted in the desirer extraction section 105. In other words, the price range check section 108 obtains the distribution of desired prices from the customer database 102, extracts a price range having a large number of customers on the distribution, and checks the tendency of the distribution of the price range. More specifically, the section 108 checks whether many customers desire a specific price or whether a certain number of customers are distributed on a plurality of desired prices. Then, the price range check section 108 transmits results of the check to parcel pattern selecting section 107 as information for pattern selection. In other words, the price range check section 108 obtains pattern selection reference information (the results of the check) to select a parcel pattern of the provided property.

Herein, extracted is a price range desired by customers more than or equal to a predetermined number, and the distribution of the extracted price range information is used as the pattern selection reference information. However, when the parcel pattern selecting section 107 described below is capable of selecting a parcel pattern, the pattern selection reference information is not limited to the aforementioned information. For example, the pattern selection reference information may be obtained in consideration of surrounding environments such as the direction and sunny aspect.

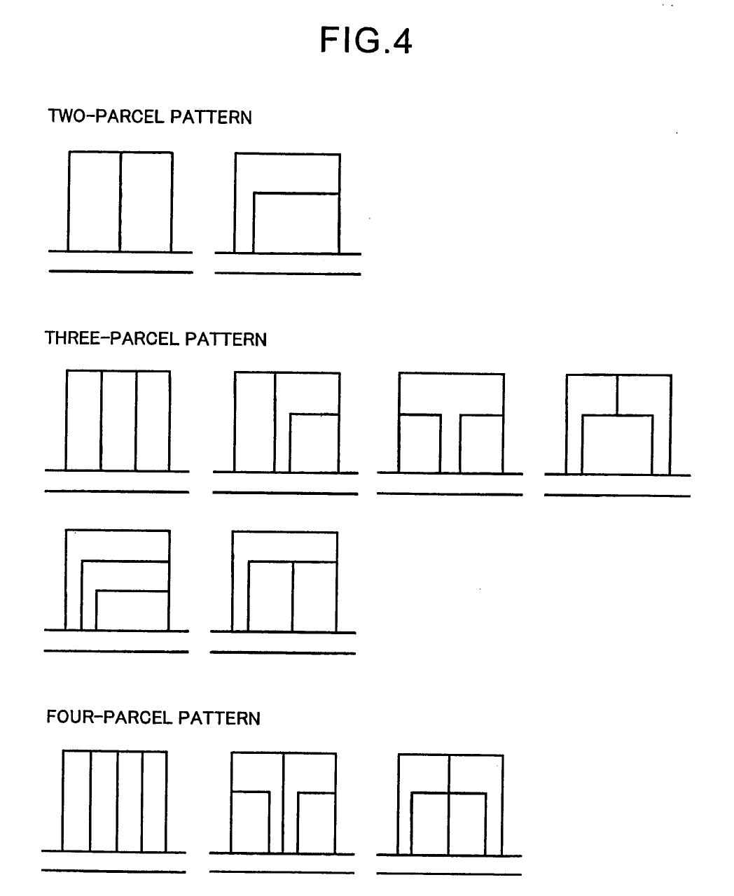

The parcel pattern selecting section 107 selects a parcel pattern from the parcel pattern database 106 based on the number of extracted desirers and information of the price range of the desirers. As the parcel pattern, for example, plane patterns as shown in FIG. 4 are considered and stored beforehand in the parcel pattern database 106. To meet such a requirement that each parcel faces a road, considered are patterns as shown in FIG. 4. While patterns up to four parcels are shown in FIG. 4, the parcel pattern database 106 stores patterns with five or more parcels. For example, in the case of patterns with five parcels, it is possible to form such patterns by combining a two-parcel pattern and a three-parcel pattern. In this way, patterns with five or more parcels are formed by combining a plurality of parcel patterns.

The parcel pattern/price determining section 109 performs matching between customers and parcels based on the pattern information selected in the parcel pattern selecting section 107, desirers extracted in desirer extraction section 105, and the price range information extracted in the price range check section 108. Then, when matching is obtained, the parcel pattern/price determining section 109 transmits the determined information (such as parcels, prices and the like) to the customers 13 from the data transmission/reception section 110 via the network 11.

In the real estate trading system according to the present invention with the aforementioned constitution, customers are extracted whose desired locations match a location of the provided property, the pattern selection reference information is obtained based on the distribution of price ranges of the extracted customers, a parcel pattern of the provided property is selected based on the pattern selection reference information and customer information, and the parcel and price information is provided to the customers based on the parcel pattern, pattern selection reference information and customer information.

By this means, the provided property is checked against desired conditions to perform matching, and it is thereby possible to search for a property matching the desired conditions promptly, and to implement a contract of estate trade early. As a result, it is possible to perform matching between a for-sale property and estate purchase desirers promptly and efficiently.

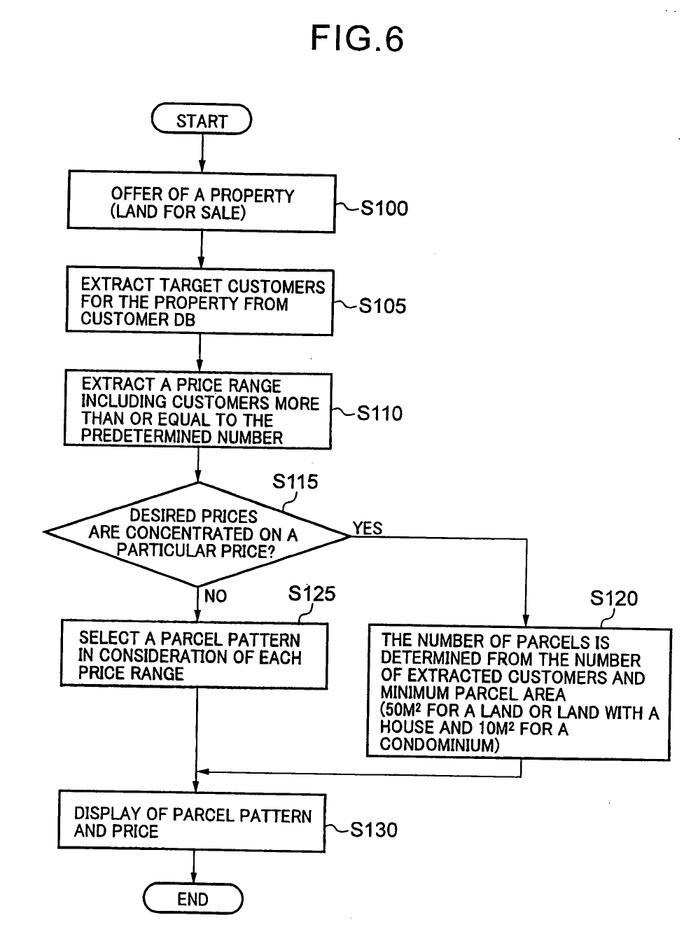

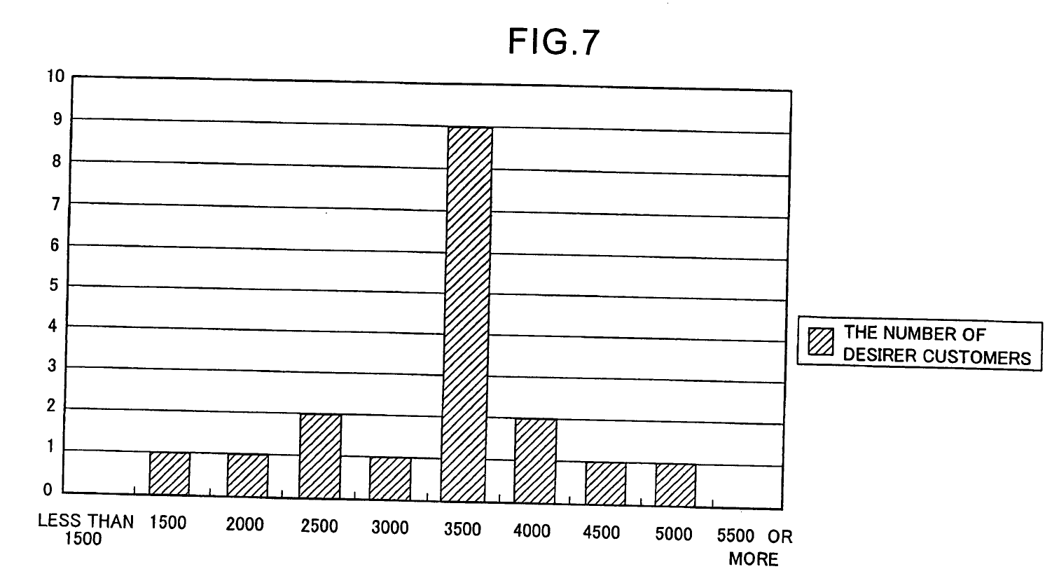

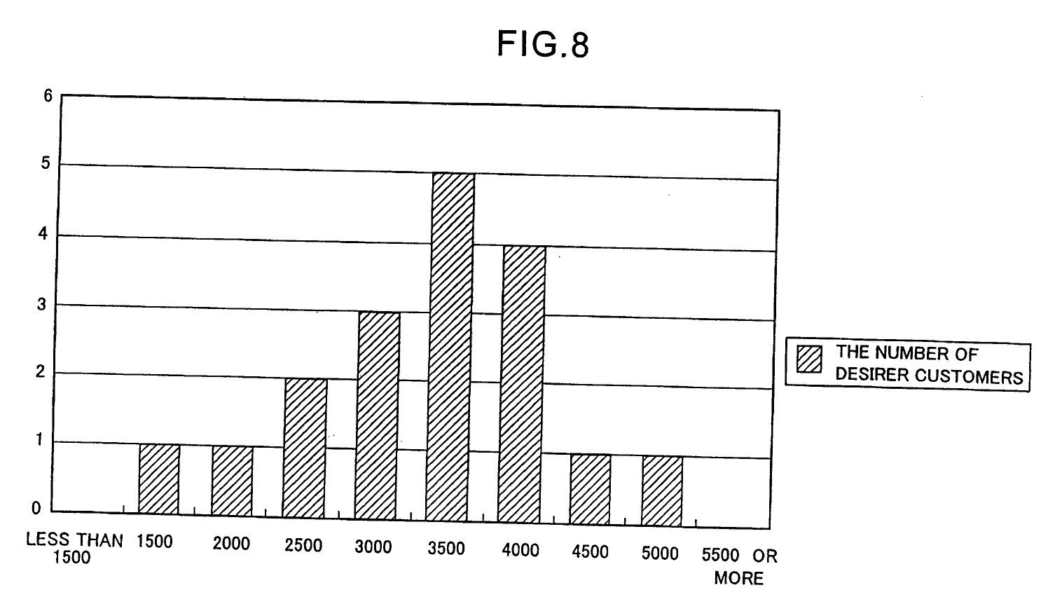

Specific examples of the real estate trading system with the aforementioned constitution will be described below with reference to FIGS. 5 to 8. FIGS. 5A to 5C are views to explain parcels in the real estate trading system according to the first embodiment of the present invention. FIG. 6 is a flowchart to explain procedures in the real estate trading system according to the first embodiment of the invention. FIGS. 7 and 8 are graphs showing distributions of the number of desirers with respect to a property to sell used in the real estate trading system according to the first embodiment of the invention.

Descriptions are given according to the flowchart in FIG. 6. First, in step S100, the estate broker 12 offers a property (land targeted for sale). The property information is transmitted from the estate broker 12 to the data transmission/reception section 110 in the estate trade management center 10. The data transmission/reception section 110 outputs the property information to the property data updating section 103. The property data updating section 103 stores the property information in the property database 104. At this point, the property data updating section 103 performs trimming on the property. In other words, when the property as shown in FIG. 5A is offered, the property data updating section 103 performs trimming on the property in the shape of a rectangle (white portion) to facilitate parceling as shown in FIG. 5B or 5C. Further, the property data updating section 103 outputs the property information to the desirer extraction section 105.

In step S105, the desirer extraction section 105 extracts customers who desire the offered property. In other words, the desirer extraction section 105 extracts customers (target customers) who desire the railroad and station nearby the offered property as the desired railroad and station from the customer database 102. More specifically, the section 105 checks the railroad and station included in the property information against railroads and stations included in the customer information stored in the customer database 102, and extracts all matching customers. The information of the extracted customers (desirers) is output to the price range check section 108, parcel pattern selecting section 107, and parcel pattern/price determining section 109.

In step S110, the price range check section 108 checks a price range including a predetermined or more number of customers. For example, the price range check section 108 checks the distribution of desired prices of the customers who desire the offered property. More specifically, the price range check section 108 checks the distribution based on the desired prices included in the customer information. Results are assumed as shown in FIG. 7 or 8. In FIG. 7 an extremely large number of customers offer 35-million yen as a desired price, while in FIG. 8 a large number of customers offer 30-million yen, 35-million yen, or 40-million yen as a desired price.

In step S115, the price range check section 108 judges the tendency of the distribution of desired prices. More specifically, the section 108 judges whether or not the desired prices are concentrated on a particular price.

In the case where the desired prices are concentrated on a particular price, in other words, in the case of the distribution as shown in FIG. 7, determined in step S120 is the number of parcels from the number of extracted customers and the minimum parcel area (50 m² in the case of a land or land with a house, and 10 m² in the case of a condominium). For example, in FIG. 7, nine customers offer 35-million yen as a desired price, and therefore, are equally sorted into three groups with three people. Then, the price range check section 108 outputs as the pattern selection reference information the information including the tendency of the distribution (FIG. 7) with the centered particular price, the centered price, and the number of extracted customers of three groups each with three customers to the parcel pattern selecting section 107 and parcel pattern/price determining section 109.

The parcel pattern selecting section 107 selects a parcel pattern based on the pattern selection reference information. In other words, since the pattern selection reference information indicates that the distribution is as shown in FIG. 7, the price is 35-million yen, and that three groups each have three customers, the section 107 selects an equal parcel pattern based on the information while referring to the parcel pattern database 106. More specifically, the section 107 selects the parcel pattern as shown in FIG. 5B.

The parcel pattern information is output to parcel pattern/price determining section 109.

In step S130, the parcel pattern/price determining section 109 determines the parcel pattern and price based on the parcel pattern information, customer information, and pattern selection reference information. The parcel and price information is transmitted to the customers 13 from the data transmission/reception section 110 via the network 11. The provision of the parcel/price information may be carried out on the network as described above, or by mail.

Meanwhile, when the desired prices are not concentrated on a particular price, in other words, in the case of the distribution as shown in FIG. 8, determined in step S125 is the number of parcels from the number of extracted customers. For example, in FIG. 8, there are three customers with 30-million yen as a desired price, five customers with 35-million yen as a desired price and four customers with 40-million yen as a desired price. In this case, parcels are graded into a low-price parcel, middle-price parcel and high-price parcel. The grading is determined as appropriate in consideration of surrounding environments such as the direction and sunny aspect. The grouping is thus carried out such that the low-price parcel (30-million yen) includes three customers, the middle-price parcel (35-million yen) includes three customers and that the high-price parcel (40-million yen) includes three customers.

The price range check section 108 outputs as the pattern selection reference information the information including the tendency of the distribution (FIG. 8) without any centered particular price, a plurality of prices (30-million yen, 35-million yen and 40-million yen), and the number of extracted customers of three groups each with three customers to the parcel pattern selecting section 107 and parcel pattern/price determining section 109.

The parcel pattern selecting section 107 selects a parcel pattern based on the pattern selection reference information. In other words, since the pattern selection reference information indicates that the distribution is as shown in FIG. 8, the prices are 30-million yen, 35-million yen and 40-million yen, and that groups are the low-price parcel including three customers, middle-price parcel including three customers and high-price parcel including three customers, the section 107 selects a parcel pattern based on the information while referring to the parcel pattern database 106. More specifically, the section 107 selects the parcel pattern as shown in FIG. 5C. The parcel pattern information is output to parcel pattern/price determining section 109.

In step S130, the parcel pattern/price determining section 109 determines the parcel pattern and price based on the parcel pattern information, customer information, and pattern selection reference information. Then, the parcel pattern and price information is transmitted to the customers 13 from the data transmission/reception section 110 via the network 11. The provision of the parcel/price information may be carried out on the network as described above, or by mail.

The customers 13 having received the information of the parcel pattern and price send a response as to whether or not to purchase to the estate broker 12 via the estate trade management center 10. Subsequently, negotiations start on a contract between the estate broker 12 and customers 13. In this way, it is made possible to implement estate trade contracts promptly and efficiently. In addition, the response as to whether or not to purchase may be sent by returning an e-mail with the information of the parcel pattern and price attached thereto, or carried out on the site of the system.

### Second Embodiment

This embodiment describes the case where a target for sale is a condominium, building or the like. Accordingly, as a parcel pattern, an elevational pattern is also used as well as the plane pattern.

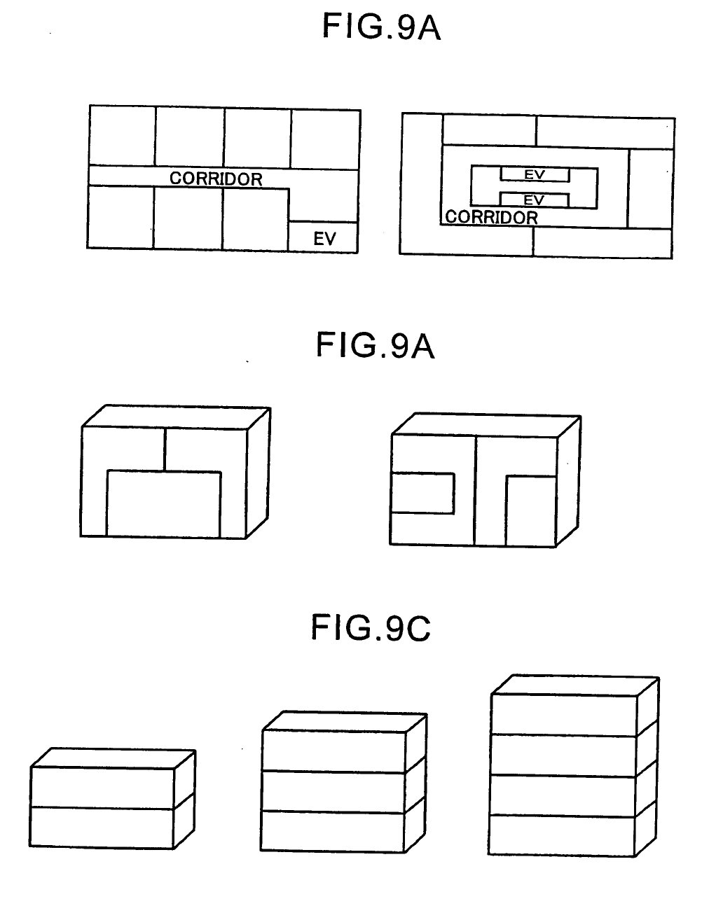

FIG. 9 is a view showing examples of a parcel pattern used in a real estate trading system according to the second embodiment of the invention. As shown in FIG. 9A, when a real-estate property is a condominium, building or the like, it is necessary to include shared portions such as an elevator (EV), corridors, stairs and the like for layout. Therefore, for example, parcel patterns as shown in FIG. 9A are used. Further, when a real-estate property is a condominium, building or the like, as well as plane patterns as shown in FIG. 9A, elevational patterns as shown in FIG. 9B are also included in parcel patterns. By thus including the elevational pattern in the parcel pattern, it is possible to respond to a customer who wants to purchase or rent a plurality of parcels (a plurality of floors). In addition, such elevational patterns include patterns with each one floor as one parcel as shown in FIG. 9C.

When a real-estate property is a condominium, parcel patterns as described above are used. The real estate trading system according to this embodiment is the same as that in the first embodiment (with respect to the system configuration as shown in FIG. 2, trade procedures as shown in FIG. 6 and the like). Accordingly, also when a real-estate property is a condominium, as in the first embodiment, it is possible to perform matching between a real-estate property for sale and estate purchase desirer promptly and efficiently.

Further, the real estate trading system according to this embodiment may enable rental cost or sales price per parcel (unit of a parcel pattern) to be set individually, or the price of a plurality of parcels or the entire building to be calculated. In this case, the rental cost or sales price per parcel is stored in the property DB 104, and the parcel pattern/price determining section 109 calculates the price of a plurality of parcels or the entire building as appropriate. By such a constitution, it is also possible to promptly present the cost of a real-estate property for sale to a customer who wants to purchase or rent a plurality of parcels (a plurality of floors).

The present invention is not limited to the above-mentioned first and second embodiments, and is capable of being carried into practice with various modifications thereof without departing from the scope of the present invention. For example, items to input and layout on an input screen on the site and parcel patterns are not limited to the above-mentioned embodiments, and are capable of being modified in various manners.

The above-mentioned first and second embodiments describe the case where a parcel pattern is determined in consideration of a price range when a plurality of desirers is extracted on a property to sell. However, in the present invention, when a plurality of desirers is extracted on a property to sell, a parcel pattern may be determined in consideration of other conditions, for example, surrounding environments such as the direction and sunny aspect.

Further, the above-mentioned first and second embodiments describe the case of performing in hardware the processing for extracting desirers and then selecting a parcel pattern. However, in the present invention, the processing for extracting desirers and then selecting a parcel pattern may be performed in software. For example, it may be possible that the processing for extracting desirers and then selecting a parcel pattern is programmed, the program is stored in ROM, and that the operation is performed by instructions of a CPU according to the program. Furthermore, it may be possible that the program is stored in a computer-readable storage medium, the program in the storage medium is stored in RAM of a computer, and that the operation is performed according to the program. Such cases also exhibit the same effects and advantages as in the above-mentioned first and second embodiments.

As described above, in the real estate trading system of the invention, customers are extracted whose desired locations are a location of an offered property, pattern selection reference information is obtained based on distribution of desired prices of the extracted customers, a parcel pattern of the offered property is selected based on the pattern selection reference information and customer information, information of the parcel and price is provided to the extracted customers based on the parcel pattern, pattern selection reference information and customer information, and it is thereby possible to perform matching between a for-sale property and estate purchase desirers promptly and efficiently.

1. A real estate trading system comprising:
customer information storage means for storing customer information including a desired location and a desired price;
customer extracting means for extracting customers who desire the desired location that is a location of an offered property;
pattern selection reference information acquiring means for acquiring pattern selection reference information based on distribution of desired prices of extracted customers;
parcel pattern selecting means for selecting a parcel pattern of the offered property based on the pattern selection reference information and the customer information; and
means for providing information of the parcel and price to the extracted customers based on the parcel pattern, the pattern selection reference information and the customer information.

2. The real estate trading system according to claim 1, wherein the pattern selection reference information includes information on whether or not desired prices of the extracted customers are concentrated on a particular price.

3. The real estate trading system according to claim 2, wherein when the desired prices of the extracted customers are concentrated on the particular price, the parcel pattern selecting means selects a parcel pattern with equally divided parcels.

4. The real estate trading system according to claim 2, wherein when the desired prices of the extracted customers are not concentrated on the particular price, the pattern selection reference information acquiring means performs grading corresponding to the desired prices of the extracted customers, and the parcel pattern selecting means selects a parcel pattern in consideration of the grading.

5. The real estate trading system according to claim 1, wherein the offered property is trimmed in the shape of a rectangle.

6. The real estate trading system according to claim 1, wherein the parcel pattern is a plane pattern.

7. The real estate trading system according to claim 6, wherein the parcel pattern includes an elevational pattern.

8. The real estate trading system according to claim 7, wherein the elevational pattern includes a pattern with each one floor as one parcel.
